(19) United States
(12) Patent Application Publication
(10) Pub. No.: US 2025/0276865 A1
(43) Pub. Date: Sep. 4, 2025

(54) Automated Raw Stock Sheet Alignment

(71) Applicant: Textron Aviation Inc., Wichita, KS (US)

(72) Inventors: Aaron Robert Heath, Wichita, KS (US); Koy Sorensen, Wichita, KS (US); Wyatt Smrcka, Wichita, KS (US); Lucas Garret Burk, Rose Hill, KS (US)

(21) Appl. No.: 18/594,451

(22) Filed: Mar. 4, 2024

(51) Int. Cl. B65H 9/20; B65H 9/10; B65H 9/12

(52) U.S. Cl. CPC B65H 9/20; B65H 9/108; B65H 9/12; B65H 2701/173

(57) ABSTRACT

This disclosure provides methods, components, devices, and systems for providing positioning and alignment of raw stock sheets during the manufacturing process. Some aspects, more specifically, relate to detecting a position of a raw stock sheet lifted from an initial position using proximity sensors and realigning the sheet to a desired position. Current techniques can cause misalignment or damage to sheets during placement. In some aspects, a raw stock sheet can be analyzed by a plurality of sensors to accurately and consistently place raw stock sheets from an initial position to a desire position for downstream manufacturing processes.

### TECHNICAL FIELD

This disclosure relates generally to aircraft production and, more specifically, to the automated alignment of raw stock sheets loaded onto machinery for downstream manufacturing processes.

### BACKGROUND

Raw stock sheets can refer to the basic, unprocessed sheets of material that are used as the starting point for creating various parts of an aircraft. These sheets can be made of various materials, including aluminum, titanium, composite materials, and other alloys, each chosen for specific properties like strength, weight, and resistance to corrosion.

Raw stock sheets are also typically large and heavy and require careful handling to ensure safety and prevent damage to the materials. The loading process for these sheets generally involves a combination of specialized equipment and precise procedures. Given the weight and size of raw stock sheets, overhead cranes are often used to lift and move them. These cranes can be manually operated or computer-controlled and can lift heavy loads. For smaller or more manageable sheets, forklifts and pallet jacks can be used.

### SUMMARY

Introduced here are methods, components, devices, and systems for automated alignment of raw stock sheets loaded onto machines for downstream manufacturing processes.

One innovative aspect of the subject matter described in this disclosure can be implemented in a method for sheet alignment during the manufacturing process. The method includes lifting a sheet from an initial position and determining a lengthwise position of the sheet by moving the sheet toward a first sensor. The method also includes adjusting an angle of the sheet based on the lengthwise position determined by the first sensor and determining a widthwise position of the sheet by moving the sheet toward a second sensor. The method further includes adjusting another angle of the sheet based on the widthwise position determined by the second sensor, and placing the sheet at a predetermined position for downstream processing.

In some examples, prior to lifting the sheet from the initial position, the method includes detecting, prior to lifting the sheet, a color of the sheet using a color detection sensor, and confirming the color corresponds with the sheet.

Another innovative aspect of the subject matter described in this disclosure can be implemented in an automated racking system. The automated racking system includes a first sensor, a second sensor, a lifting mechanism, one or more memories that store processor-executable code, and one or more processors coupled with the one or more memories and individually or collectively configured to, in association with executing the code, cause the automated racking system to lift a sheet from an initial position using the lifting mechanism. The automated racking system is also configured to determine a lengthwise position of the sheet by moving the sheet toward the first set of sensors and determine a widthwise position of the sheet by moving the sheet toward a second sensor. The automated racking system is further configured to adjust angles of the sheet based on an initial lengthwise position determined by the first set of sensors and an initial widthwise position determined by the second sensor and place the sheet at a predetermined position for downstream processing.

An additional innovative aspect of the subject matter described in this disclosure can be implemented in one or more computer storage media. The one or more computer storage media storing computer-useable instructions that, when executed by one or more computing devices, cause the one or more computing devices to perform operations, including determining a position of a sheet lifted above an initial position by moving the sheet toward a plurality of sensors, adjusting an angle of the sheet based on the position determined by the plurality of sensors, and placing the sheet at a predetermined position for downstream processing.

This summary is intended to introduce a selection of concepts in a simplified form that is further described in the detailed description section of this disclosure. The summary is not intended to identify key or essential features of the claimed subject matter, nor is it intended to aid in determining the scope of the claimed subject matter. Additional objects, advantages, and novel features of the technology will be set forth in the following description and, in part, will become apparent to those skilled in the art upon examination of the disclosure or learned through practice of the technology.

### BRIEF DESCRIPTION OF THE DRAWINGS

These and other features, aspects, and advantages of the embodiments of the disclosure will become better understood with regard to the following description, appended claims, and accompanying drawings where:

FIG. 1 is a block diagram of an example sheet alignment system for providing raw stock sheet placement and alignment from an originating position to a processing position, in accordance with embodiments of the present disclosure.

FIGS. 2A-2H are example diagrams of a sheet alignment system aligning and positioning a raw stock sheet, in accordance with embodiments of the present disclosure.

FIG. 3 is an example flowchart for providing raw stock sheet placement and alignment from an originating position to a processing position, in accordance with embodiments of the present disclosure.

FIG. 4 illustrates a block diagram of an exemplary computing device, in accordance with embodiments of the present disclosure.

While the present disclosure is amenable to various modifications and alternative forms, specifics thereof, have been shown by way of example in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

This disclosure relates generally to the automated alignment of raw stock sheets loaded onto machines for processing. The following description is directed to some particular examples for the purpose of describing innovative aspects of this disclosure. However, a person having ordinary skill in the art will readily recognize that the teachings herein can be applied in a multitude of different ways.

### Overview

Raw stock metal sheets are a fundamental component in aircraft production, playing a crucial role in constructing various parts of an aircraft. The use of these sheets can involve several stages, from an initial design and material selection to a final installation.

Typically, raw stock sheets arrive at a manufacturing facility on pallets, where individual pieces can be moved from the pallets to worktables. From there, they can be cut and shaped into the necessary parts. This can be done using various methods like Computer Numerical Control (CNC) machining, laser cutting, waterjet cutting, or traditional mechanical methods like sawing and shearing.

At a manufacturing facility, moving large raw stock sheets, such as those used in aircraft production or other heavy industries, requires careful handling and specialized equipment to ensure safety and efficiency. For moderate-sized sheets, forklifts are commonly used. They can lift and transport the sheets from storage areas to the workstations. For very large or heavy sheets, overhead cranes are often employed. These cranes can lift and move the sheets over obstacles and place them where needed.

When placing raw stock sheets into machinery for processing, hard stops can be used to align the sheets to ensure precise and consistent positioning of the materials. A hard stop is a physical barrier or a fixed point against which a workpiece can be placed to ensure it is in the correct position before processing begins.

Hard stops provide a consistent reference point for placing each sheet. This is crucial in operations where multiple sheets need to be processed in the same way. By using hard stops, workers can quickly and accurately position sheets without having to measure or mark each one individually. Additionally, hard stops reduce the chance of human error in positioning the sheets. This is especially important in precision manufacturing where even small misalignments can lead to defects or inconsistencies in the final product.

In automated or semi-automated systems like CNC machines, hard stops are set up to ensure that each sheet is positioned correctly before machining begins. This helps in achieving high precision in cutting, drilling, or shaping processes. As such, hard stops are frequently used tools in alignment of raw stock sheets in manufacturing. They ensure consistency and reduce the likelihood of errors.

Limitations on conventional raw stock sheet alignment techniques remain, however, as these techniques can result in damaging raw stock sheets during alignment. This is especially true for thinner sheets. For instance, using a hard stop on thin raw stock sheets can cause the edges that come into contact with the hard stops to crinkle and bend. In some instances, this can result in the entire sheet being unusable for machining. Other techniques, such as manual alignment, can be a slow and laborious process that can be time-consuming and prone to error.

Various aspects of the disclosure improve existing technologies and techniques described herein, as well as others, by providing methods, components, systems, and devices that support positioning and alignment of raw stock sheets for processing at a manufacturing facility. Some aspects particularly relate to automated alignment using proximity sensors to detect the positioning of edges along a raw stock sheet. During manufacturing, raw stock sheets are moved from an initial position, such as a pallet, and placed onto a worktable for processing or machining. Upon selecting a raw stock sheet, sensors can be utilized to accurately align the edges of the sheet and place the sheet on a worktable such that sheets are placed onto the worktable in a consistent manner without additional force being applied to the edges of the sheet.

Particular aspects of the subject matter described in this disclosure can be implemented to realize one or more of the following potential advantages. The present disclosure aims to provide accurate positioning and proper alignment of raw stock sheets during the manufacturing process by implementing mechanisms that evaluate the raw stock sheet during movement. By providing positioning and alignment mechanisms, manufacturing facilities can place raw stock sheets for processing without damaging or bending the sheets.

### Example Automated Racking System

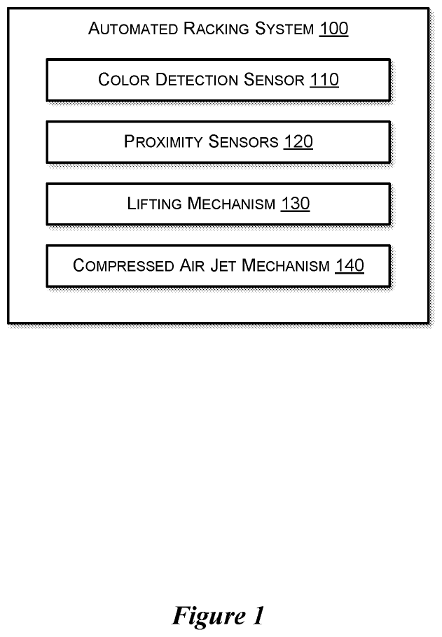

FIG. 1 shows a block diagram of an example automated racking system 100 suitable for use in implementing embodiments of the disclosure. The automated racking system 100 is configured to reposition raw stock sheets and align them for downstream manufacturing processes. The automated racking system 100 is further configured to detect raw stock sheets and remove any additional sheets that may be attached via friction during the repositioning process. According to some aspects, the automated racking system 100 can include a color detection sensor 110, proximity sensors 120, a lifting mechanism 130 coupled to a rotatable arm, and a compressed air jet mechanism 140.

The color detection sensor 110 is a component of the automated racking system 100 configured to detect raw stock sheets located at an initial position. For instance, raw stock sheets can be placed on a pallet in proximity to the automated racking system 100. During the repositioning process, each sheet can be lifted and removed. Before each lift, the color detection sensor 110 can be used to detect whether a sheet is available on the pallet or whether there are no sheets remaining on the pallet.

In some aspects, the color detection sensor 110 emits light (e.g., from an light emitting diode (LED)) onto the raw stock sheet it is analyzing. The light can reflect back from the sheet to the color detection sensor 110, which can then detect the color of the light. This detection can be based on the red, green, blue (RGB) color model. If the color corresponds with a raw stock sheet, then the automated racking system 100 can determine that a raw stock sheet is available from a pallet or initial position.

In some aspects, the color detection sensor 110 includes an emitter, a receiver, a processor, and an output interface (not shown). As discussed, the emitter can be an LED or other light-emitting device that can emit light onto a target object. The receiver can be a photodiode or a similar sensor that can capture the reflected light. This component can be sensitive to the intensity of the different wavelengths of light, allowing it to detect color. A microprocessor coupled to the emitter and receiver can interpret the data received. It can convert this data into a usable color reading that can be interpreted by the automated racking system 100. The output interface can be a digital signal or an analog signal that can interface with a computing device (e.g., see FIG. 5) to provide color data for further analysis or action by the automated racking system 100.

In some aspects, the color detection sensor 110 can be implemented using a variety of color detection sensors. These sensors include, but are not limited to, RGB color sensors, spectral color sensors, colorimeters, photodiode array sensors, fluorescence sensors, fiber optic color sensors, smart color sensors, and the like. For instance, a fiber optic color sensor can utilize fiber optic technology to detect color. Light is transmitted through a fiber optic cable, reflected off the object, and then transmitted back through the cable to a detector.

The proximity sensors 120 are components of the automated racking system 100 configured to detect the presence of nearby objects without any physical contact. For instance, the proximity sensors 120 can be positioned in such a way as to detect the positioning of a raw stock sheet along an x-axis and y-axis, or the lengthwise or widthwise position of the sheet. Upon lifting a raw stock sheet from its initial position, the raw stock sheet requires reorientation to its final predetermined position (e.g., placed on a worktable) in a known alignment requirement. Additionally, slight adjustments are required to ensure that the placement of the sheets are properly aligned. By the proximity sensors 120 sensing both sides of a raw stock sheets, the automated racking system 100 can make adjustments to ensure proper alignment of the sheet upon placement.

The proximity sensors 120 are configured to detect objects by emitting an electromagnetic field or a beam of electromagnetic radiation (e.g., infrared) and then sensing changes in the field or return signal. Using these techniques, the proximity sensors 120 can detect different kinds of materials, including metal, plastic, wood, and liquids, depending on their type.

In some aspects, the proximity sensors 120 are implemented using a variety of proximity sensors. These sensors include, but are not limited to, inductive proximity sensors, capacitive proximity sensors, optical proximity sensors, ultrasonic proximity sensors, and magnetic proximity sensors. For instance, ultrasonic proximity sensors can emit ultrasonic waves and detect the reflection from nearby objects. Additionally, these sensors can also determine the distance to the object.

The proximity sensors 120 are further configured to measure the distance of an object in relation to a respective sensor. In some aspects, the proximity sensors 120 are configured as ultrasonic sensors that measure the time it takes for the sound waves to bounce back (time of flight). The distance to the object can be calculated based on the time delay. In some aspects, the proximity sensors 120 are configured as optical proximity sensors. Optical proximity sensors, similar to ultrasonic sensors, can measure the time it takes for light to travel to the object and back. In some implementations, the optical proximity sensors utilize a triangulation method that involves using the angle of reflection of the light from the object. The sensor can emit a beam of light (e.g., a laser), which can reflect off the object and is detected at an angle. The distance can be calculated using the principles of triangulation.

In some implementations, the proximity sensor is configured as a capacitive proximity sensor. These sensors are configured to measure distance by detecting changes in capacitance caused by the proximity of an object. An object moves closer to the sensor, the capacitance increases in a measurable way. By calibrating the sensor, the distance can be inferred from the capacitance value.

The lifting mechanism 130 is a component of the automated racking system 100 configured to lift a raw stock sheet from an initial position and place the sheet at a predetermined final position for downstream manufacturing processes. In some implementations, the lifting mechanism is configured as a suction gripper, also known as a vacuum gripper. A suction gripper is a type of lifting mechanism designed to lift objects by creating a vacuum between the gripper and the surface of the object.

In some implementations, the lifting mechanism configured as a suction gripper includes suction cups or pads, a vacuum generator, valves and controls, a mounting frame, and vacuum sensors. When the suction cups are placed against the metal sheet, the vacuum generator can evacuate air from the cups, creating a vacuum. The vacuum causes atmospheric pressure to press the cups against the sheet, creating a strong enough force to lift the metal. In some implementations, the size and number of suction cups are designed based on the weight and size of the sheets to be lifted. This can vary based on the dimensions and thickness of the sheets. To release the sheet, air is allowed back into the suction cups, breaking the vacuum and releasing the grip.

The compressed air jet mechanism 140 is a component of the automated racking system 100 configured to provide compressed air directed toward a raw stock sheet lifted by the lifting mechanism 130. The compressed air jet mechanism 140 can provide the directed compressed air to perform various tasks, ranging from vibrating the raw stock sheet to cleaning and removing any debris that may be present on the sheets. In some implementations, the compressed air jet mechanism 140 includes an air compressor, a storage tank, a distribution system, control valves, and air jets (not shown).

In some implementations, the air compressor draws in ambient air and compresses it to the desired pressure. The storage tank can hold the compressed air, providing a steady supply and evening out potential pressure fluctuations. The air jets can direct the flow of air onto specific areas of a raw stock sheet.

It is noted that FIG. 1 is intended to depict the major representative components of an automated racking system 100. In some embodiments, however, individual components may have greater or lesser complexity than, as represented in FIG. 1, components other than or in addition to those shown in FIG. 1 may be present, and the number, type, and configuration of such components may vary.

### Example Use Case Sequence Diagram

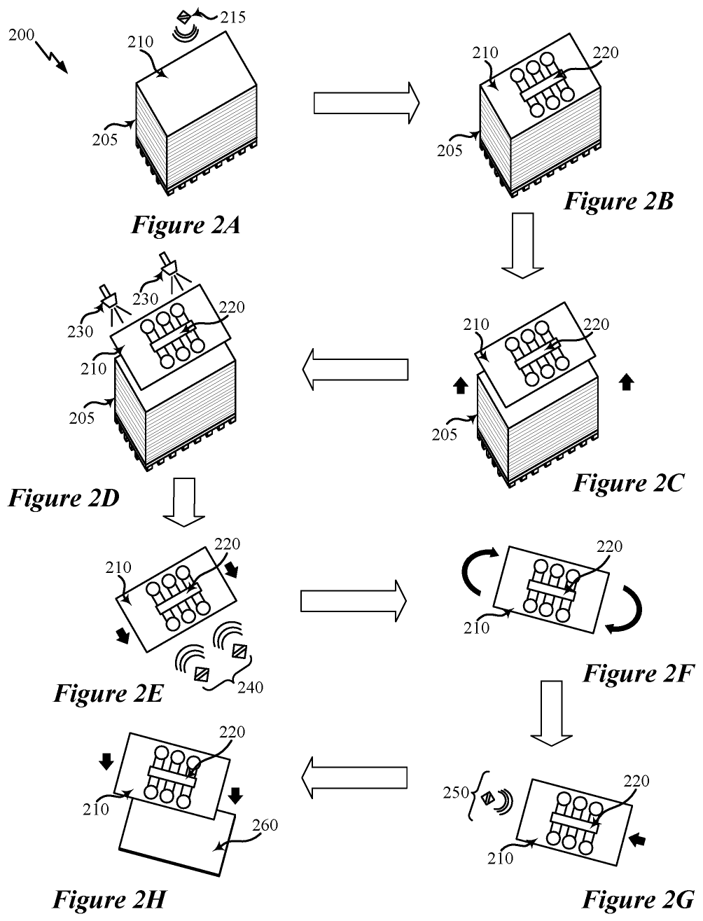

FIGS. 2A-2H show a sequence diagram 200 of an example use case scenario of an automated racking system (substantially similar to the automated racking system 100 of FIG. 1) lifting raw stock sheets from a pallet and aligning the sheets onto a worktable for a downstream manufacturing process, in accordance with embodiments of the present disclosure. According to some aspects, the sequence diagram 200 represents a procedure that can occur by the automated racking system to move and reposition raw stock sheets from an initial position (e.g., a pallet) to a predetermined position (e.g., a worktable) and align the sheets onto the predetermined position without the need for physical stops that can potentially damage the sheets. Additionally, in some aspects, the sequence diagram 200 illustrates how the automated racking system ensures that only the sheet is moved and repositioned at a time. This can occur by implementing mechanisms that detach potential sheets attached to a lifted sheet by way of friction or other means.

As shown, in FIG. 2A, the sequence diagram 200 includes a pallet of raw stock sheets 205, a raw stock sheet 210 at the top of the sheet stack, and a color detection sensor 215 (substantially similar to the color detection sensor 110 of FIG. 1). In FIG. 2A, the color detection sensor 215 is activated to analyze the surface of the raw stock sheet 210. In some aspects, the purpose of analyzing the surface of the raw stock sheet 210 is to ensure that a sheet is available for lifting off of the pallet. As discussed, the color detection sensor 215 can emit light onto the raw stock sheet 210. The light can reflect back from the sheet 210 to the color detection sensor 215, which can then detect the color of the light. If the color corresponds with that of a raw stock sheet, then the automated racking system can proceed. However, if the color does not correspond with a raw stock sheet, then the automated racking system can pause until the pallet is replaced with additional sheets.

As shown, in FIG. 2B, the sequence diagram 200 includes the pallet of raw stock sheets 205, the raw stock sheet 210 at the top of the stack, and a lifting mechanism 220 (substantially similar to the lifting mechanism 130 of FIG. 1). In FIG. 2B, the lifting mechanism 220 attaches to the raw stock sheet 210. In some aspects, the lifting mechanism 220 is a suction gripper that applies suction to suction cups to provide sufficient purchase to the raw stock sheet 210.

As also shown, in FIG. 2C, the lifting mechanism 220 raises the raw stock sheet 210 above the pallet of raw stock sheets 205. While not shown, the lifting mechanism 220 includes a robotic arm capable of providing reach, maneuverability, and the ability to lift and move objects. In some aspects, the robotic arm can include multiple jointed sections, which can include rotational (revolute) joints, linear (prismatic) joints, or a combination of both. These joints provide degrees of freedom, allowing the arm to move the raw stock sheet 210.

In FIG. 2D, the sequence diagram 200 proceeds by providing compressed air via air jets 230 (substantially similar to the compressed air jet mechanism 140 of FIG. 1) to the lifted raw stock sheet 210. In some situations, when the raw stock sheet 210 is lifted off of the stack of other sheets, other sheets may also be lifted as well. This can occur due to several possible factors related to the physical properties of the sheet and the environmental conditions. These factors include, but are not limited to, magnetic attraction, static electricity, surface adhesion, vacuum effect, and mechanical interlocking. For instance, very smooth surfaces can stick together due to the van der Waals force, a type of molecular attraction. In other instances, when two flat surfaces are very close together, the air between can be pushed out, creating a partial vacuum. Atmospheric pressure then holds the sheets together.

In order to remove any potentially attached sheet that may still be attached to the lifted raw stock sheet 210, the automated racking system can introduce compressed air over the surface of the raw stock sheet 210. The compressed air can cause the raw stock sheet 210 to vibrate and oscillate, causing any potentially attached sheet to detach and return to the pallet of raw stock sheets 205.

In some implementations, the lifting mechanism 220 can move up and down to further cause the raw stock sheet 210 to oscillate and vibrate. The additional movement can also assist in removing any potentially attached sheets, allowing them to detach and return to the pallet of raw stock sheets 205.

As shown, in FIG. 2E, the sequence diagram 200 illustrates the lifting mechanism 220 jogging the lengthwise side of raw stock sheet 210 toward two proximity sensors 240 (substantially similar to proximity sensors 120 of FIG. 1). In some implementations, the proximity sensors 240 can detect the edges of the lengthwise segment of the raw stock sheet 210. Once detected, the proximity sensors 240 can each detect the position of each edge based on the respective sensor 240.

As shown in FIG. 2F, the sequence diagram 200 illustrates the lifting mechanism 220 making rotational adjustments to the sheet 210. Based on the positions provided by the proximity sensors 240, and having a proper alignment and placement requirement, the automated racking system can adjust the lengthwise side of the sheet such that it corresponds with a proper alignment required when placed on the worktable.

In some implementations, the lifting mechanism 220 can jog the lengthwise side of raw stock sheet 210 toward the two proximity sensors 240 (not shown) in the adjusted positioning. The proximity sensors 240 can detect the edges of the lengthwise segment of the raw stock sheet 210. Once detected, the proximity sensors 240 can cause the lifting mechanism to stop movement of the raw stock sheet 210.

As shown, in FIG. 2G, the sequence diagram 200 illustrates the lifting mechanism 220 jogging the widthwise side of the raw stock sheet 210 toward a proximity sensor 250 (substantially similar to proximity sensors 120 of FIG. 1). In some implementations, the proximity sensor 250 can detect the edge of the widthwise segment of the raw stock sheet 210. Once detected, the proximity sensor 250 can detect the distance the edge is from the proximity sensor 250. Based on the distances provided by the proximity sensor 250, and having a proper alignment and placement requirement, the automated racking system can adjust the widthwise side of the sheet such that it corresponds with the proper alignment required when placed on the worktable.

In some implementations, based on the measurements provided by the sensors 240, 250, the automated racking system can determine how much the sheet 210 is offset in both the lengthwise and widthwise directions. Based on those measurements, the automated racking system can calculate how much movement is needed to move the sheet into proper alignment. For example, if the sheet is two inches away from the desired position lengthwise and one inch widthwise, the automated racking system can move the sheet 210 two inches in one direction and one inch in the perpendicular direction.

Once the raw stock sheet 210 is properly aligned to correspond with a predetermined position, as shown in FIG. 2H, the sequence diagram 200 illustrates the lifting mechanism 220 lowering the raw stock sheet 210 into position at a worktable 260 or some other destination where the raw stock sheet 210 can be used for some other downstream manufacturing process.

### Example Flow Diagram

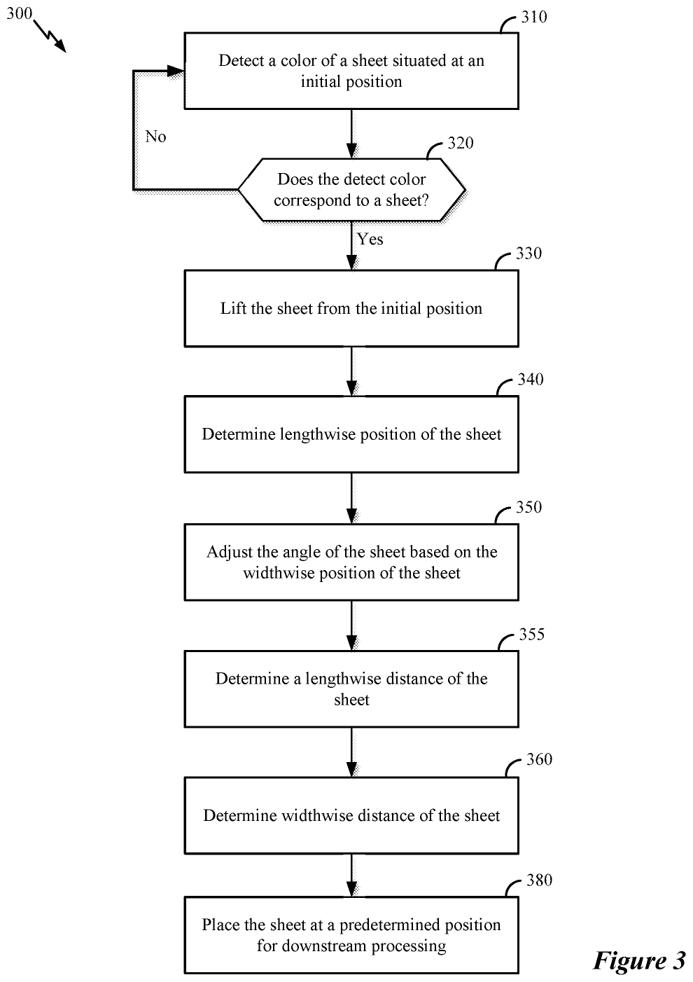

With reference to FIG. 3, a flow diagram illustrating a method is provided. Each block of the method 300 and any other methods described herein include a computing process performed using any combination of hardware, firmware, and/or software. For instance, in some embodiments, various functions are carried out by a processor executing instructions stored in memory. In some cases, the methods are embodied as computer-usable instructions stored on computer storage media.

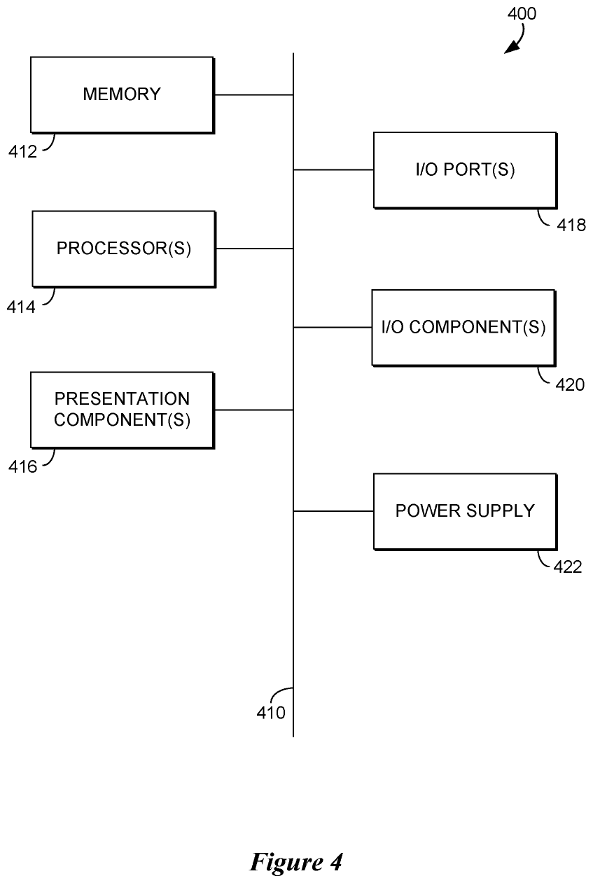

FIG. 3 illustrates a method 300 of a series of acts in a method of positioning a raw stock sheet onto a worktable in proper alignment, in accordance with embodiments of the present disclosure. In one or more embodiments, the method 300 is performed in a digital medium environment instructing by mechanical devices including the automated racking system 100. In some examples, the method 300 may be performed by a computing device such as the one of the computing device 400, described with reference to FIGS. 4. The method 300 is intended to be illustrative of one or more methods in accordance with the present disclosure and is not intended to limit potential embodiments. Alternative embodiments can include additional, fewer, or different steps than those articulated in FIG. 3.

As illustrated in FIG. 3, the method 300 includes an optional block 310 that detects a color of a sheet situated at an initial position. In some instances, the sheet is a raw stock metal sheet positioned on a pallet. In some implementations, a color detection sensor is used to detect the color of the sheet. As discussed, a color detection sensor can emit light onto the sheet it is analyzing. The light can reflect back from the sheet to the color detection sensor, which can then detect the color of the light.

At optional block 320, the method 300 includes determining whether the color detected corresponds to the color of a sheet. For instance, the sheet can be a raw stock metal sheet that can have varying degrees of metallic grey colors. If the color detected corresponds to a color that closely resembles or matches that of a metallic grey, then the method 300 can proceed to block 330. However, if the color does not correspond to a sheet, then the method 300 pauses and returns to detecting a color of the sheet. This can be repeated until replacement sheets are positioned proximate to the color detection sensor.

At block 330, the method 300 includes lifting the sheet from the initial position. In some implementations, a lifting mechanism, such as a suction gripper, coupled to a robotic arm, attaches to the sheet and lifts the sheet from the initial position. In some implementations, compressed air, via air jets, is shot over the surface of the lifted sheet causing the sheet to vibrate and oscillate to remove any sheets that may be stuck, or otherwise attached, to the lifted sheet. In some implementations, the lifting mechanism moves up and down to further vibrate and oscillate the lifted sheet to remove any sheets that may be stuck or attached to the lifted sheet.

At block 340, the method 300 includes determining a lengthwise position of the lifted sheet. In some implementations, the lifting mechanism jogs the sheet toward a sensor to determine the position of the edge of the sheet. In some aspects, two proximity sensors are positioned adjacent to each other to allow the sensors to detect the position of the edges of the lengthwise position of the sheet.

At block 350, the method 300 includes adjusting an angle of the sheet based on the lengthwise position determined by the sensor. In some implementations, the two proximity sensors can provide the positioning of each edge of sheet. Based on a known alignment requirement, the lifting mechanism can be used to adjust the lengthwise position of the sheet such that it corresponds with the known alignment requirement.

At block 355, the method 300 includes determining a lengthwise distance of the lifted sheet. In some implementations, the lifting mechanism jogs the sheets toward two proximity sensors positioned adjacent to each other to allow the sensors to detect the distances of the edges of the lengthwise position of the sheet. In some implementations the proximity sensors are the same sensors used to determine the positioning of the sheet.

At block 360, the method 300 includes determining a widthwise distance of the lifted sheet. In some implementations, the lifting mechanism jogs the sheet toward a sensor to determine the widthwise distance of the edge of the sheet. In some aspects, a proximity sensor is positioned to allow the sensor to detect the distances of the edge of the widthwise position of the sheet.

In some implementations, the lifting mechanism jogs the sheet toward two sensors along the lengthwise position to determine edge distances from the sensors and then jogs the sheet toward a sensor along the widthwise position to determine edge distances from those sensors. Once determined, the lifting mechanism can be used to adjust the lengthwise position and the widthwise position to correspond to the known alignment requirement.

At block 380, the method 300 includes placing the sheet at a predetermined position in the known alignment requirement. In some implementations, the sheet is placed on a worktable to allow for further downstream manufacturing processing of the sheet.

### Example Operating Environment

Having described an overview of embodiments of the present technology, an example operating environment in which embodiments of the present technology may be implemented is described in order to provide a general context for various aspects of the present technology. Referring now to FIG. 4, in particular, an exemplary operating environment for implementing embodiments of the present technology is shown and designated generally as computing device 400. Computing device 400 is but one example of a suitable computing environment and is not intended to suggest any limitation as to the scope of use or functionality of the technology. Neither should computing device 400 be interpreted as having any dependency or requirement relating to any one or combination of components illustrated.

The technology of the present disclosure may be described in the general context of computer code or machine-useable instructions, including computer-executable instructions such as program modules, being executed by a computer or other machines, such as a personal data assistant or other handheld devices. Generally, program modules, including routines, programs, objects, components, data structures, etc., refer to code that performs particular tasks or implement particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

Having described an overview of embodiments of the present technology, an example operating environment in which embodiments of the present technology may be implemented is described in order to provide a general context for various aspects of the present technology. Referring now to FIG. 2, in particular, an exemplary operating environment for implementing embodiments of the present technology is shown and designated generally as computing device 2100. Computing device 2100 is but one example of a suitable computing environment and is not intended to suggest any limitation as to the scope of use or functionality of the technology. Neither should computing device 2100 be interpreted as having any dependency or requirement relating to any one or combination of components illustrated.

The technology of the present disclosure may be described in the general context of computer code or machine-useable instructions, including computer-executable instructions such as program modules, being executed by a computer or other machines, such as a personal data assistant or other handheld devices. Generally, program modules, including routines, programs, objects, components, data structures, etc., refer to code that performs particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 4, computing device 400 includes bus 410 that directly or indirectly couples the following devices: memory 412, one or more processors 414, one or more presentation components 416, input/output ports 418, input/output components 420, and illustrative power supply 422. Bus 410 represents what may be one or more buses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component, such as a display device, or an I/O component. Also, processors have memory. We recognize that such is the nature of the art and reiterate that the diagram of FIG. 4 merely illustrates an example computing device that can be used in connection with one or more embodiments of the present technology. A distinction is not made between such categories as “workstation,” “server,” “laptop,” “hand-held device,” etc., as all are contemplated within the scope of FIG. 4 and reference to “computing device.”

Computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer storage media and communication media.

Computer storage media include volatile and nonvolatile, removable, and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 412 includes computer storage media in the form of volatile or nonvolatile memory. The memory may be removable, non-removable, or a combination thereof. Examples of hardware devices include solid-state memory, hard drives, optical-disc drives, etc. Computing device 400 includes one or more processors that read data from various entities, such as memory 412 or I/O components 420. Presentation component(s) 416 presents data indications to a user or other device. Examples of presentation components include a display device, speaker, printing component, vibrating component, etc.

I/O ports 418 allow computing device 400 to be logically coupled to other devices, including I/O components 420, some of which may be built in. Illustrative components include a microphone, joystick, game pad, satellite dish, scanner, printer, wireless device, etc.

The present invention may be a system, a method, and/or a computer program product at any possible technical detail level of integration. The computer program product may include a computer-readable storage medium (or media) having computer readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (R.O.M.), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (I.S.A.) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (P.L.A.) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Having identified various components in the present disclosure, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions, etc.) can be used in addition to or instead of those shown.

The subject matter of the present disclosure is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. For purposes of this disclosure, words such as “a” and “an,” unless otherwise indicated to the contrary, include the plural as well as the singular. Thus, for example, the requirement of “a feature” is satisfied where one or more features are present.

The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information), and the like. Also, “determining” can include resolving, selecting, obtaining, choosing, establishing, and other similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware, and software has been described generally in terms of functionality and illustrated in the various illustrative components, blocks, modules, circuits, and processes described above. Whether such functionality is implemented in hardware, firmware, or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein but are to be accorded the widest scope consistent with this disclosure, the principles, and the novel features disclosed herein.

Additionally, various features that are described in this specification in the context of separate examples also can be implemented in combination in a single implementation. Conversely, various features that are described in the context of a single implementation can also be implemented in multiple examples separately or in any suitable subcombination. As such, although features may be described above as acting in particular combinations, and even initially claimed as such, one or more features from a claimed combination can, in some cases, be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated into the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A method of sheet alignment, the method comprising:
lifting a sheet from an initial position;
determining a lengthwise position of the sheet by moving the sheet toward a set of sensors;
adjusting an angle of the sheet based on the lengthwise position determined by the first sensor;
determining a lengthwise distance of the sheet by moving the sheet toward the set of sensors;
determining a widthwise distance of the sheet by moving the sheet toward a second sensor; and
placing the sheet at a predetermined position for downstream processing based on the lengthwise distance and widthwise distance of the sheet.

2. The method of claim 1, further comprising:
providing compressed air over a surface of the sheet causing the sheet to vibrate, thereby removing an attached second sheet back to the initial position.

3. The method of claim 1, further comprising:
detecting, prior to lifting the sheet, a color of the sheet using a color detection sensor; and
confirming the color corresponds with the sheet.

4. The method of claim 1, further comprising:
oscillating, prior to determining the lengthwise position, the sheet using a lifting mechanism used for lifting the sheet from the initial position.

5. The method of claim 1, wherein the sheet is raw stock metal sheet.

6. The method of claim 1, wherein a suction gripper is used to lift the sheet from the initial position.

7. The method of claim 1, wherein the set of sensors includes two proximity sensors positioned to detect edges of the lengthwise position of the sheet.

8. The method of claim 1, wherein the second sensor includes a proximity sensor positioned to detect an edge of a widthwise position of the sheet.

9. The method of claim 1, wherein the sheet has a thickness between 0.010 inches to 0.100 inches.

10. The method of claim 1, wherein the set of sensors and the second sensor are proximity sensors.

11. An automated racking system comprising:
a set of sensors;
a second sensor;
a lifting mechanism;
one or more memories that store processor-executable code; and
one or more processors coupled with the one or more memories and individually or collectively configured to, in association with executing the code, cause the automated racking system to:
lift a sheet from an initial position using the lifting mechanism;
determine a lengthwise position and a lengthwise distance of the sheet by moving the sheet toward the set of sensors;
determine a widthwise distance of the sheet by moving the sheet toward the second sensor;
adjust angles of the sheet based on the lengthwise position determined by the first sensor; and
place the sheet at a predetermined position for downstream processing based on the lengthwise distance and the widthwise distance.

12. The automated racking system of claim 11, wherein the automated racking system includes a compressed air mechanism, wherein the one or more processors further cause the automated racking system to:
provide compressed air, using the compressed air mechanism, over a surface of the sheet causing the sheet to vibrate, thereby removing an attached second sheet back to the initial position.

13. The automated racking system of claim 11, wherein the automated racking system includes a color detection sensor, wherein the one or more processors further cause the automated racking system to:
detect, prior to lifting the sheet, a color of the sheet using the color detection sensor; and
confirm the color corresponds with the sheet.

14. The automated racking system of claim 11, wherein the one or more processors further cause the automated racking system to:
oscillate, prior to determining the lengthwise position, the sheet using a lifting mechanism used for lifting the sheet from the initial position.

15. The automated racking system of claim 11, wherein the sheet is raw stock metal sheet.

16. The automated racking system of claim 11, wherein a suction gripper is used to lift the sheet from the initial position.

17. The automated racking system of claim 11, wherein the first sensor includes two proximity sensors positioned to detect edges of the lengthwise position of the sheet.

18. The automated racking system of claim 11, wherein the second sensor includes a proximity sensor positioned to detect an edge of a widthwise position of the sheet.

19. The automated racking system of claim 11, wherein the sheet has a thickness between 0.010 inches to 0.100 inches.

20. One or more computer storage media storing computer-useable instructions that, when executed by one or more computing devices, cause the one or more computing devices to perform operations comprising:
determining a position of a sheet lifted above an initial position by moving the sheet toward a plurality of sensors;
adjusting an angle of the sheet based on the position determined by the plurality of sensors; and
placing the sheet at a predetermined position for downstream processing.
